(19) United States
(12) Patent Application Publication
(10) Pub. No.: US 2026/0173029 A1
(43) Pub. Date: Jun. 18, 2026

(54) OPERATING A COMMUNICATION SYSTEM FOR A MOTOR VEHICLE

(71) Applicant: AUDI AG, Ingolstadt (DE)

(72) Inventor: Alexander Gummer, Ingolstadt (DE)

(73) Assignee: AUDI AG, Ingolstadt (DE)

(21) Appl. No.: 19/424,592

(22) Filed: Dec. 18, 2025

(30) Foreign Application Priority Data
Dec. 18, 2024 (DE) 10 2024 138 626.6

(51) Int. Cl. H04W 64/00; H04L 41/16; H04W 4/021; H04W 4/46; H04W 4/90

(52) U.S. Cl. CPC H04W 64/006; H04L 41/16; H04W 4/021; H04W 4/46; H04W 4/90

(57) ABSTRACT

A method of operating a communication system for a motor vehicle that provides a first communication area for data communication with a communication device. By at least one drone, a position map having at least one position in a surrounding area of the motor vehicle may be determined autonomously, at which a second communication area, different from the first, is provided in each case for the motor vehicle for the data communication with the communication device. By the at least one drone, a repositioning signal may be transmitted to the motor vehicle, wherein the repositioning signal contains the at least one position of the determined position map, so that the motor vehicle can be repositioned from its current position to the at least one position. The motor vehicle is connected upon the positioning on the at least one position to the vehicle-external communication device for the data communication.

### CROSS-REFERENCE TO RELATED APPLICATIONS

This application claims the priority benefit of German Patent Application No. 10 2024 138 626.6 filed on Dec. 18, 2024, which is incorporated by reference herein in its entirety.

### BACKGROUND

### 1. Field

An invention according to described examples relates to a method for operating a communication system for a motor vehicle. The invention according to the examples also relates to a corresponding communication system for a motor vehicle.

### 2. Description of Related Art

Networked vehicles play a central role in the modern automobile industry. Many vehicle systems directly access data sources in the Internet to provide current information such as traffic conditions, weather conditions, and map data in real time. This connectivity is an essential feature which is increasingly expected by the customer. In particular in higher priced vehicles, or those which are conceived for adventure or off-road uses. Manufacturers have made significant advances in recent years in the integration of onboard computers, sensors, and infotainment systems, which continuously communicate with backend servers. The outsourcing of complex computing operations to the backend has the advantage that the computing capacity and the energy consumption in the vehicle itself can be reduced.

Some manufacturers have even already developed systems which enable software updates, remote diagnoses, and even vehicle-internal control via the Internet. The necessity for a continuous Internet connection is therefore essential in many vehicles. Moreover, the demand for continuous Internet connection is increasing due to the growing trend for digitization and the integration of services such as speech assistants, streaming services, and cloud-based applications.

A further feature of modern vehicles is the increasing integration of driving assistance systems and autonomous driving functions. These systems often depend on real-time data from the Internet to function reliably and efficiently. Thus, for example when navigating in the urban space, a constant connection is necessary to analyze traffic flows in real time and adapt the route planning accordingly. The connectivity is also important in the off-road area, for example, to acquire topographic data or current weather information, which are important for safe driving through difficult terrain.

In spite of the progressive networking and digitization of vehicles, there are significant challenges, in particular in the context of off-road use. In remote areas, such as mountain regions, forests, or deserts, the network coverage is often inadequate. This results in frequent interruptions of the Internet connection, which in turn impair the functionality of driver assistance systems and other Internet-based services. These interruptions may not only endanger the safety, but also significantly impair the comfort and the satisfaction of the driver.

Dead zones which are caused by geographic conditions such as valleys, hills, or dense forests represent a problem for passengers of the vehicle. In such situations, it is not possible for the vehicle to establish a stable Internet connection to the cell tower. The dependence on a continuous Internet connection has the result that many functions of the vehicle are not available, which can result in critical situations as in the case of a breakdown or an accident, and can become an additional problem during longer stationary stops, for example when camping.

A further disadvantage is the uncertainty which arises for the driver when the connectivity is lost. Many drivers depend strongly on the digital systems of their vehicle and feel helpless in the case of a network loss. This uncertainty can become stronger in stressful situations, as in difficult weather conditions or when navigating through unknown terrain.

Some vehicle manufacturers have begun to work on the integration of drones in their vehicles to assist specific vehicle functions. The drones are configured, for example, to explore the surroundings or record photos or videos. However, there is also the concept of using a drone as a communication bridge and thus enabling a stable connection, for example, to the internet.

For example, DE 10 2023 103 604 A1 discloses a method for operating a communication system in a factory. The communication system comprises a movement unit movable in a driverless manner based on a communication signal and at least one communication unit, by which the communication signal is provided in a signal range. The communication signal is provided if needed in a movement range of the movement unit that is located outside the signal range by at least one drone here.

DE 10 2023 126 963 A1 discloses a system for improved coverage of satellite communication by an unmanned aircraft. The system is configured here so that it transmits control instructions to the unmanned aircraft in order to control positioning of the aircraft in the air relative to the vehicle and to a satellite.

DE 10 2015 012 311 A1 discloses a method for transmitting an emergency call data set from a motor vehicle to a radio network. A flying object is used here in order to transport an emergency call data set away from the motor vehicle in the case of an emergency event and transmit the emergency call data set via a radio network.

### SUMMARY

An example object of the present invention according to described examples may be to expand the possible uses of a drone in a communication system for a motor vehicle.

The example object may be achieved by the subjects of the independent claims. Advantages for the refinement in the invention according to the example may be disclosed by the dependent claims, the description, and the figures.

According to one aspect, the invention according to the examples relates to a method for operating a communication system for a motor vehicle. The motor vehicle provides a first communication area for data communication with a vehicle-external communication device. The communication device is located here outside the first communication area. The respective communication area is in particular an area in which the motor vehicle can receive data or signals from the communication device and vice versa. The respective communication area specifies as the reception range of the motor vehicle. If the communication device is thus located within the first communication area, the communication device and the motor vehicle are connected or coupled to one another by a communication connection for signal exchange. If the communication device is located outside the range, in contrast, a communication connection is not possible. There is thus no connection to a corresponding radio network. This can occur, for example, if the motor vehicle is located in a remote region, as was described at the outset, for example.

To nonetheless enable a communication connection, in the invention according to the example, at least one drone, thus one or more unmanned aircraft or flying objects, is used. By use of the at least one drone, a position map having at least one position in a surrounding area of the motor vehicle is autonomously determined, at which in each case a second communication area different from the first is provided for the motor vehicle for data communication with the vehicle-external communication device. The vehicle-external communication device is located here within the second communication area.

In other words, the drone determines the second communication area for the motor vehicle. The second communication area is selected here so that the vehicle-external communication device is located within the range. A communication connection between motor vehicle and communication device is therefore possible.

By the at least one drone, a repositioning signal is now transmitted to the motor vehicle. The repositioning signal contains the at least one position of the determined position map here, so that the motor vehicle can be repositioned or moved from its current position to the at least one position. During the positioning on the at least one position, the motor vehicle is connected to the vehicle-external communication device for the data communication.

If the motor vehicle thus carries out the position change, its first communication area is shifted, specifically to the second communication area. In the second communication area, the motor vehicle and the communication device are directly connected to one another in the communication connection. The communication device is then located in the reception range of the motor vehicle.

The drone can thus propose to the motor vehicle, in particular to a driver of the motor vehicle, to carry out a position change in order to adopt a position having better reception for the communication device. In particular, the driver decides whether the position change is carried out. That is to say the driver can move or steer the motor vehicle for the repositioning from the current position to the determined position.

The advantage results in this way that a connection, for example, to the Internet is enabled even in remote regions. This meets the expectation of vehicle users for continuous networking and at the same time improves the functionality of Internet-based services in the vehicle.

The data communication in the present case may refer to a signal transmission by radio signals, for example by a mobile radio. For this purpose, the motor vehicle, the communication device, and also the at least one drone can be equipped with a suitable radio module, for example with an antenna.

The vehicle-external communication device can be, for example, a radio mast or radio tower or a combination thereof. The communication device can thus represent a radio network. By the communication device, for example, it is possible to access data from a server, in particular a backend server or a combination of computer networks. In an example, the computer networks may be a worldwide combination of computer networks, which are also referred to in general as the Internet.

The position map can be understood in particular as a three-dimensional map of the surroundings or the studied surrounding area of the motor vehicle. In addition to a topography of the surroundings, the one or more positions having good reception for the motor vehicle for the communication device can also be specified in the position map, for example.

To determine the position map, the drone is autonomously operated in a flight mode. Autonomously means here that the drone carries out all required functions or control maneuvers for movement in the air independently. The drone thus carries out the functions automatically and therefore without action of an operator, such as the user of the motor vehicle. The user comfort is thus enhanced. The driver does not have to perform complicated settings or manually control the drone. The process of signal amplification or signal extension takes place in a transparent and intuitive manner.

To determine the position map, the drone carries out a reception search. For this purpose, it flies in the flight mode through the surrounding area and collects surroundings data. The surroundings data can comprise, for example, the topography of the surroundings and positions having good reception for the communication device.

The respective position can be specified in the form of geocoordinates in three-dimensional space. To detect positions having good reception, the drone can connect itself to the communication device in a communication connection if they are in reception range in relation to one another. The drone now measures the signal strength to the communication device and assesses it. If the signal strength exceeds a predetermined threshold value, for example, the reception can be classified as accordingly good and the assigned position can be stored as a position in the position map.

The drone can have a camera system, for example, for capturing the surroundings, in particular its topography. The drone can generate a depiction of the surroundings using the camera system and evaluate it according to known methods. Alternatively, the drone can receive the topography on the basis of GNSS signals (GNSS: global navigation satellite system).

The surrounding area can be an area around the motor vehicle in which the drone can still be in communication connection to the motor vehicle when determining the position map. Alternatively, the surrounding area is, for example, an area which is assigned or corresponds to an energetic range of the drone. The range is determined in particular by a state of charge of an energy storage device of the drone.

The drone may be transported or stored in a storage unit of the motor vehicle when it is not used for the communication system. For the determination of the position map, the drone leaves the storage unit in order to capture the surrounding area. The storage unit can comprise a charging interface and/or a changing station for an energy storage device of the drone.

The motor vehicle can comprise a human-machine interface (HMI) for controlling the drone or its functions. Operating fields for the control of the drone can be provided via the HMI, for example. A user of the motor vehicle can operate these operating fields and thus control the drone. The control can comprise, for example, the takeoff on a search flight for determining the position map. Furthermore, the user can accept or decline the repositioning via the HMI, for example, so that the drone returns to the motor vehicle, for example. Of course, other drone functions, such as recording videos or camera images in the surroundings or controlling the drone flight, can also be enabled via the HMI.

The examples of the invention may result in additional advantages.

In an example, it is checked whether an emergency call for the motor vehicle and/or at least one passenger of the motor vehicle is required according to a predetermined emergency call criterion. An emergency call signal of the motor vehicle is transmitted to an emergency call service by the at least one drone only if the emergency call is required. The transmission takes place, for example, by the vehicle-external communication device; the drone can thus be used to take over an emergency call for the motor vehicle which presently does not have reception from a radio network.

Due to the possibility of establishing a connection to the mobile radio network even in remote regions, emergency services can be contacted or breakdown assistance can be requested quickly in an emergency. This enhances the safety for drivers and occupants, in particular in critical situations.

To determine whether an emergency call is necessary, emergency call data or breakdown data of the motor vehicle can be evaluated. For example, a roadworthiness status can be retrieved from an onboard computer and/or a health status of the respective passenger can be determined. A corresponding health sensor can be used, for example, to measure a blood pressure, a pulse, and/or a blood sugar value for this purpose.

The emergency call criterion now contains specifications or information about which conditions the emergency call data are to be viewed as an emergency. For example, a limiting value or a limiting interval can be specified in the emergency call criterion. By comparing the emergency call data with the stored conditions, it can be decided whether or not the emergency call is necessary. If the emergency call is necessary, the emergency call signal can be transferred from the motor vehicle, for example, in the form of an emergency call data packet to the drone, thus transmitted to the drone by the communication connection, for example. The drone can move away from the motor vehicle with the emergency call data packet and place the emergency call. For this purpose, the drone only needs to have, for example, a radio connection to an arbitrary communication device. A connection to the motor vehicle no longer needs to exist.

The emergency call service can be, for example, a fire department, an emergency service or a towing service, or another emergency call service.

In an example, only for the case that a passenger of the motor vehicle declines the repositioning according to the repositioning signal, a signal amplifier unit is positioned at a position specified in the determined position map by the at least one drone. That is to say the drone transports the signal amplifier unit to the respectively determined position and puts it down there. In the present case, this is thus a mobile signal amplifier unit. The motor vehicle is connected, for the data communication in the second communication area, to the vehicle-external communication device via the signal amplifier unit.

Therefore, the first communication area is thus expanded to the second communication area using the signal amplifier unit. The signal amplifier unit can therefore be used as an interface for the data communication between motor vehicle and communication device. It can thus be used for the signal amplification of a communication signal which the motor vehicle and the communication device wish to exchange with one another. For this purpose, the signal amplifier unit is connected, on the one hand, to the communication device and, on the other hand, to the motor vehicle in a communication connection. The data communication therefore takes place indirectly by means of the signal amplifier unit.

The signal amplifier unit is also referred to in communication technology as a repeater. The signal amplifier unit can, for example, likewise be transported in the storage unit of the motor vehicle when it is not used for the signal amplification.

The repositioning signal can be declined or accepted, for example, by an input of the passenger, for example via the HMI mentioned at the outset. The passenger can be a driver or a fellow passenger of the motor vehicle.

In an example, only for the case that a passenger of the motor vehicle declines the positioning according to the repositioning signal, at least one drone which has a signal amplifier unit is positioned at a position specified in the determined position map. The motor vehicle is now connected, for the data communication in the second communication area, to the vehicle-external communication device via this signal amplifier unit of the at least one drone.

The first communication area is thus also expanded here, as previously described. The drone is used as an interface for the data communication between motor vehicle and communication device. The data communication or signal transmission thus takes place indirectly by the at least one drone.

The drone as an interface has proven to be helpful in particular if the determined position is far from the ground, thus is in the air. This is because the drone has the advantage that, in contrast to the motor vehicle and to the signal amplifier unit, it can move in three-dimensional space.

The respective drone can have the signal amplifier unit installed or it can transport a mobile signal amplifier unit, as was described above, for example, and therefore hold it in the air at the desired position.

In an example, it is provided only for the case that the motor vehicle is in a driving mode that the at least one drone adapts its respective position depending on a respectively current position of the motor vehicle. The at least one drone only adopts those positions in this case which have been determined in the position map and at which the second communication area is provided.

The drone is thus operated in a following flight. It follows the vehicle movements dynamically and maintains the communication connection to the motor vehicle and the communication device in this case. The drone can particularly update the position map in the following flight mode. If the motor vehicle adopts a position during the journey, for example, at which it has reception again itself, the following flight may be ended. The drone then returns to the motor vehicle, for example, and is stowed in the storage unit.

In an example, the at least one drone comprises a data processing device having a machine-trained algorithm. By the machine-trained algorithm, at least one probability position is determined in the surroundings, for which the surroundings data specify according to a predetermined probability that the second communication area is provided, depending on captured surroundings data. The at least one drone accordingly only flies to the at least one probability position to determine the respective positions of the position map.

At the respective probability position, the drone can check the reception or the signal strength, as described at the outset. If good reception for the motor vehicle is present there, the drone can confirm the probability position as a position of the position map. Otherwise, the position is discarded. The flight path for the drone can thus be optimized overall. This is because the drone does not need to fly around arbitrarily in the surrounding area in order to detect positions having good reception. Instead, positions having probably good reception are calculated deliberately, which the drone then flies toward.

The drone determines the probability positions on the basis of the probabilities that good reception is expected at the respective position. For this purpose, the drone studies and assesses the captured surroundings data which, as described at the outset, for example, contain the topography of the surroundings. The algorithm can have been trained in this case, for example, for the situation that worse reception prevails in valleys than in regions located higher up, for example.

A machine-trained algorithm in particular means a program or a function implemented as software and/or directly as hardware. The data processing device stores this program, which comprises or represents the machine-trained algorithm, or contains the corresponding hardware. Such an algorithm is also referred to colloquially as artificial intelligence.

In an example, experience values of the motor vehicle or of an other motor vehicle are used by the at least one drone to determine the at least one position of the position map. The experience values contain at least one previously known position in the surrounding area, at which the second communication area is provided.

That is to say the position map is at least partially prepared on the basis of known positions. The positions are known from the experience values for the respective surrounding area. The positions can be previously known, for example, if the motor vehicle or the other motor vehicle have already been located once in the surrounding area and a corresponding position map was already prepared once by means of its respective drone. That is to say the experience values can contain an already prepared position map. The experience values for the respective surrounding area can be retrieved, for example, from a backend server or from a data memory of the motor vehicle.

In an example, according to a variant, at least one second energy storage device is provided for the at least one drone in the motor vehicle. Depending on an energy storage device status of an energy storage device currently used by the drone, the drone moves autonomously toward the motor vehicle in order to exchange or have exchanged the energy storage device currently used by the drone for the at least one second energy storage device.

Additionally or alternatively, in a further variant, at least one second energy storage device is also provided for the signal amplifier unit in the motor vehicle. The at least one drone moves the signal amplifier unit autonomously to the motor vehicle depending on an energy storage device status of the energy storage device currently used by the signal amplifier unit, in order to exchange the energy storage device currently used by the signal amplifier unit for the at least one second energy storage device.

Additionally or alternatively, it is provided in a further variant that at least one further signal amplifier unit is provided in the motor vehicle. Depending on an energy storage device status of an energy storage device currently used by the signal amplifier unit, the drone moves autonomously to the motor vehicle in order to exchange the signal amplifier unit for the at least one further signal amplifier unit.

It can therefore be ensured that the motor vehicle has the most extensive possible reception for the communication device. The drone can thus ensure that during longer service life, for example of several days, the respective energy storage device, thus, for example, a replaceable accumulator or a battery, is exchanged. For this purpose, for example, the drone or the motor vehicle itself monitors the energy storage device status of the respective energy storage device. The energy storage device status means in particular a state of charge, thus the remaining energy of the energy storage device, for the power supply of the drone or the signal amplifier unit. The respective energy storage device can be exchanged automatically, for example with a corresponding mechanism in the storage unit, or it can be changed by a passenger of the motor vehicle.

Alternatively, of course, it is conceivable that the drone or the signal amplifier unit for charging return or are brought back to the motor vehicle. For this purpose, a corresponding charging station can be provided in the storage unit.

In an example, a status signal is provided to the motor vehicle to display a current operating status for a passenger by means of the at least one drone and/or the respective signal amplifier unit. The operating status comprises in this case an energy storage device status of a respectively currently used energy storage device of the at least one drone or the respective signal amplifier unit and/or the position map determined up to this point and/or a progress of the drone in determining the position map.

That is to say the drone and/or the signal amplifier unit can send status messages to the motor vehicle, so that a passenger can obtain the overview. The drone or the signal amplifier unit can transmit the status signal via the communication connection to the motor vehicle.

According to one aspect, the invention according to the examples also relates to a communication system for a motor vehicle. The communication system comprises the motor vehicle, a vehicle-external communication apparatus, and at least one drone. The motor vehicle has a first communication area for data communication with the vehicle-external communication device. The vehicle-external communication device is located outside the first communication area, however. That is to say the communication device is located outside a reception range of the motor vehicle, which is specified by the first communication area.

The at least one drone is now configured to autonomously determine a position map having at least one position in a surrounding area of the motor vehicle, at which a second communication area, which is different from the first, for the motor vehicle for the data communication with the vehicle-external communication device is provided in each case. The vehicle-external communication device is located here within the second communication area. That is to say, it is located within the reception range of the motor vehicle for the second communication area.

The at least one drone is furthermore configured to transmit a repositioning signal to the motor vehicle, wherein the repositioning signal contains the at least one position in the determined position map, so that the motor vehicle can be repositioned from its current position to the at least one position. The motor vehicle is connected here during the positioning on the at least one position to the vehicle-external communication device for the data communication.

Therefore, a method according to the examples of the invention can be executed or carried out using the described communication system.

The motor vehicle according to the examples of the invention may be an automobile, for example, a passenger car or truck, or as a bus or motorcycle.

The invention according to the examples also includes a data processing device for the respective drone. The data processing device or processor device (processor circuit) is configured to carry out the method according to the examples of the invention. The processor device can have for this purpose at least one microprocessor and/or at least one microcontroller and/or at least one FPGA (Field Programmable Gate Array) and/or at least one DSP (Digital Signal Processor). In particular, a CPU (Central Processing Unit), a GPU (Graphical Processing Unit), or an NPU (Neural Processing Unit) can each be used as the microprocessor. Furthermore, the processor device can have program code which is configured to carry out the method according to the examples of the invention when it is executed by the processor device. The program code can be stored in a data memory of the processor device. The processor device can be based, for example, on at least one printed circuit board and/or on at least one SoC (System on Chip).

As a further solution, the invention according to the examples also comprises a computer-readable storage medium, comprising program code, which, when it is executed by a computer or a computer network, causes it to carry out the method according to the examples of the invention. The storage medium can be provided at least partially as a nonvolatile data memory (for example as a flash memory and/or as an SSD-solid state drive) and/or at least partially as a volatile data memory (for example as a RAM-random access memory). The storage medium can be arranged in the computer or computer network. The storage medium can also be operated, for example, as a so-called app store server and/or cloud server in the Internet, however. A processor circuit having, for example, at least one microprocessor can be provided by the computer or computer network. The program code can be provided as binary code and/or as assembler code and/or as source code of a programming language (for example C) and/or as program script (for example Python). The computer-readable storage medium can alternatively be implemented by a signal having computer-readable data, for example a time-variant voltage signal and/or a radio signal.

The invention according to the examples and the refinement of the communication system according to the examples of the invention having features, as have already been described in conjunction with the refinements of the method according to the examples of the invention. For this reason, the corresponding refinements of the communication system according to the examples of the invention are not described once again here.

The invention according to the examples also comprises the combinations of the features of the described examples. The invention according to the examples thus also comprises implementations which each have a combination of the features of several of the described examples, if the examples have not been described as mutually exclusive.

### BRIEF DESCRIPTION OF THE DRAWINGS

Examples of the invention are described hereinafter. In the figures:

FIG. 1 shows a schematic representation of a communication system for drone-based data communication between a motor vehicle and a communication device; and

FIG. 2 shows a schematic method flow chart for a method for operating a corresponding communication system.

### DESCRIPTION

The examples explained hereinafter are examples of the invention. In the examples, the described components of the examples each represent individual features of the examples of the invention which are to be considered independently of one another and each also refine the examples of the invention independently of one another. The disclosure is therefore also to comprise combinations of the features of the examples other than those shown. Furthermore, the described examples can also be supplemented by further of the features of the examples of the invention which have already been described.

In the figures, identical reference signs each identify functionally identical elements.

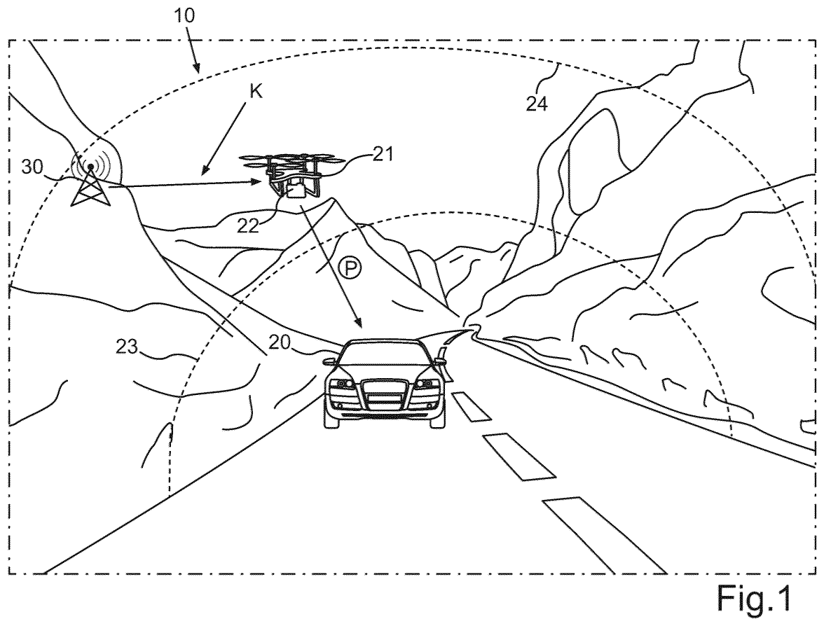

FIG. 1 shows a schematic representation of a communication system 10 for a motor vehicle 20. The communication system 10 comprises, in addition to the motor vehicle 20, a drone 21 and a communication device 30. The communication device 30 is represented in the present case by a radio mast or transmitting tower, as is used in communication technology for radio communication. A communication connection to a combination of computer networks and therefore, for example, an Internet connection for the motor vehicle can be established via the radio mast. For this purpose, the motor vehicle 20 would have to be in a reception range of the communication device 30 and vice versa.

The reception range of the motor vehicle 20 is represented in the present case by a first communication area 23. As shown in the situation in FIG. 1, the motor vehicle 20 is located, for example, in remote terrain, in the present case a mountainous region. The communication device 30 is therefore outside the first communication area 23. The motor vehicle 20 thus cannot be connected to the Internet, which represents a challenge in particular in networked vehicles. Thus, it may namely occur that, for example, complex computing operations for operating the motor vehicle, which are executed in a vehicle-external backend server, are no longer possible. Operating driving assistance systems or analyzing traffic flows in real time or using other Internet-based services is therefore also no longer available.

In an example, a solution is now to be provided in order to nonetheless enable data communication K in the case of a lack of Internet connectivity of the motor vehicle 20 to the communication device 30. The data communication K may take place by radio signals, for example mobile radio signals. For this purpose, the motor vehicle 20, the drone 21, and the communication device 30 can comprise a respective radio module.

To provide the data communication K, a connection option is searched for using different algorithms by the drone 21 coupled to the motor vehicle 20 and this connection option is then established. A second communication area 24 for the motor vehicle 20 can therefore be implemented with the aid of the drone, within which the communication device 30 is located in the reception range of the motor vehicle 20.

FIG. 1 shows an example in which the second communication area 24 is expanded in comparison to the first communication area 23. The reception range of the motor vehicle 20 is therefore enlarged. However, there are also examples in which the second communication area 24 is implemented in that the first communication area 23 is shifted, thus offset to another position.

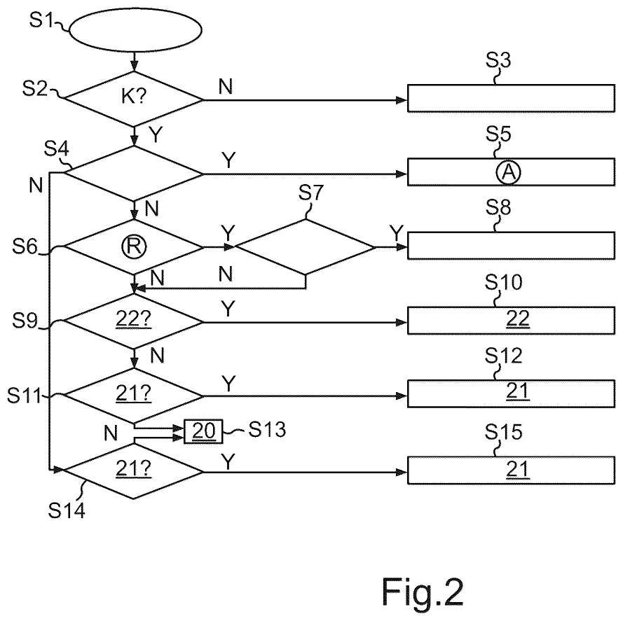

The various possibilities for enabling the data communication K in a drone-based manner are described in more detail in FIG. 2. FIG. 2 shows for this purpose a schematic method flow chart for a method for operating the communication system according to FIG. 1.

In a step of the S1 of the method, a reception search is initially carried out by the drone 21. For this purpose, the drone 21 is sent on an autonomous, for example, AI-optimized search flight, in which it studies and three-dimensionally maps the Internet reception in the vicinity of the motor vehicle 20. The drone 21 thus flies around in a surrounding area of the motor vehicle 20 in the flight mode and prepares a position map, for example, a three-dimensional reception map, having one or more positions at which the second communication area 24 for the motor vehicle 20 is provided. In order to complete the flight mode autonomously, the drone 21 may be equipped in a known manner with required camera and sensor systems.

For this purpose, the drone checks in a step of the S2 whether a connection is possible at the respective position to the communication device 30. For this purpose, for example, it can measure and evaluate the signal strength at the respective position. If no connection is possible (N), the method is continued in a step S3. In step S3, the drone 21 transmits a response to a driver of the motor vehicle 20 that no matching communication device 30 was found. The response can be output in a motor vehicle, for example, by a human-machine interface (HMI), for example via a display or a screen.

In contrast, if a connection is possible (Y) according to step S2, the method is continued in a step S4. In step S4, it is checked whether an emergency call is required for a passenger of the motor vehicle or the motor vehicle itself. This is the case, for example, if the motor vehicle 20 has been in an accident or a passenger requires immediate aid for health reasons. If the motor vehicle 20 or a corresponding emergency sensory system of the motor vehicle 20 recognizes that an emergency call is required (Y), the method is continued in a step S5.

In step S5, an emergency call is placed by the drone 21. For this purpose, it can network with an emergency call module of the motor vehicle 20 and record or receive an emergency call data packet therefrom. The drone 21 can then move away from the motor vehicle 20, specifically to a position which is known from the position map, for example, at which an Internet connection exists. The drone 21 can then transmit an emergency call signal A having the emergency call data packet by the communication device 30 to an emergency call service, such as a fire department, an ambulance service, or a towing service. If the drone 21 is still located in the reception range of the motor vehicle 20, the drone 21, for example, as a connection interface between the communication device 30 and the motor vehicle 20, can also establish a speech connection to the respective passenger of the motor vehicle and the emergency call service.

In contrast, if it turns out in step S4 that an emergency call is not necessary (N), the method is continued in a step S6. In step S6, the drone checks, for example, whether repositioning for the motor vehicle 20 is possible at the determining position of the position map. For this purpose, the drone 21 can use, for example, the known topography in exploring the surroundings. That is to say, if the drone 21 detects Internet reception at a point reachable using the vehicle, it proposes repositioning of the motor vehicle 20. For this purpose, the drone 21 can transmit a repositioning signal R that contains the respective position to the motor vehicle 20. The position can be displayed to the driver of the motor vehicle 20, for example, via the screen of the HMI. If the repositioning is possible, the method is continued in a step S7.

In step S7, it is checked whether the repositioning is accepted by the driver. For this purpose, an operating field for selection can be displayed to the driver via the screen, for example, via which the driver can accept or decline the new position by an input. If the driver accepts the repositioning (Y), the method is continued in a step S8.

In step S8, the driver can reposition the motor vehicle 20, thus move or repark it from its current position to the determined position. The driver can thus establish an Internet connection to the communication device 30 via conventional methods, thus directly, by the reparking. Therefore, the first communication area 23 is shifted by the reparking so that the communication device 30 is located within the reception range of the motor vehicle 20, which is indicated at the new position by the second communication area 24. This procedure is suitable in particular for stationary applications, for example when camping.

In contrast, if the driver does not accept the repositioning or repositioning is not possible because, for example, the position cannot be reached by the motor vehicle 20, the method is continued in a step S9. In step S9, it is checked whether signal amplification is possible by a repeater, thus a signal amplifier unit 22. For this purpose, the drone 21 checks, for example, on the basis of the topography of the surroundings known from the position map whether the position is located at a point reachable for the repeater. If the determined position meets this requirement (Y), the method is continued in a step S10.

In step S10, the drone 21 places the signal amplifier unit 22 in the surroundings, thus at the determined position, so that the signal can be forwarded from the point having reception to the motor vehicle 20. A stationary connection solution can thus be provided.

By the repeater, the first communication area 23 is thus expanded or enlarged to the second communication area. The data communication K between communication device 30 and motor vehicle 20 takes place indirectly by the signal amplifier unit 22. In order to enable the exposure at a point having adequate reception, the signal amplifier unit 22 may be mobile and battery-operated. The limited usage period of the signal amplifier unit 22 is not relevant due to the low power consumption of the function for expanding the communication area (in particular less than 15 Watt). During longer service life, for example of several days, the battery, thus an energy storage device of the signal amplifier unit, can be, for example, changed by the drone or the repeater can be retrieved for charging by the drone or exchanged for a further repeater. In contrast, if it turns out in step S9 that the determined position for the signal amplifier unit 22 is not accessible (N), the method is continued in a step S11.

In step S11, the drone 21 checks whether signal amplification is possible by the drone 21 itself. For this purpose, the drone checks by measuring the signal strength whether, for example, positions far from the ground, thus positions in the air, are provided with adequate reception. If the drone 21 finds one or more corresponding positions (Y), the method is continued in a step S12.

In step S12, the signal amplification may be performed in a stationary manner by of the drone. For this purpose, the drone 21 likewise has a signal amplifier unit 22 and moves to the determined position in order to remain stationary in the air there, in order to establish the connection between communication direction 30 and motor vehicle 20. The first communication area 23 is thus also expanded or enlarged here to the second communication area 24, specifically by the drone 21 itself. The data communication K thus takes place by the drone 21. The signal amplifier unit 22 can be an integral component of the drone 21 or the drone 21 can hold and transport the mobile signal amplifier unit 22 in the air.

To counter the limited flight of the drone, which is generally approximately 25 to 30 minutes, a second energy storage device, thus a replaceable battery, can be stored in the motor vehicle 21. This can be exchanged for the discharged one in an automated and rapid manner at the motor vehicle 20.

Alternatively to the stationary signal amplification by the drone 21, dynamic signal amplification by the drone 21 is also conceivable. For this purpose, it is checked in a step S14 whether dynamic signal amplification by the drone 21 is required. This is the case, for example, if the motor vehicle 20 does not remain stationary at a position, but rather moves along a mountain pass through the mountains, for example. For this purpose, the motor vehicle 20 can communicate to the drone 21, for example, that it continues to move and therefore dynamic signal amplification is necessary. In an example, step S14 is carried out in parallel or as an alternative to step S6. If dynamic signal amplification is considered to be necessary in step S14, the method is continued in a step S15.

In step S15, the signal amplification by the drone 21 takes place dynamically, thus while motor vehicle 20 is driving. The drone 21 follows the motor vehicle in the flight mode autonomously in this case and matches its speed and flight path, for example, in an AI-optimized manner, to that of the motor vehicle 20 so that the best possible Internet connection is always ensured. Assistance systems which require a connectivity, for example, can also be used during the journey due to this type of establishing the connection. To ensure the best possible Internet connection, the drone 21 moves, for example, along the positions which it has determined according to the position map during the search flight. The drone 21 can update the position map in the flight, so that an Internet connection permanently exists for the motor vehicle 20.

If it turns out in steps S11 or S14 that signal amplification by the drone 21 is not possible (N), the method is continued in a step S13. This is the case, for example, if the drone 21 cannot establish a connection to the communication device 30 during the reception search.

In step S13, the reception search by the drone 21 is terminated and the drone 21 may return to the motor vehicle 20. When not in use, the drone may be stowed in a storage compartment or a storage unit in the motor vehicle 20, in order to be protected from dirt and weather. A battery charging and replacement station for the drone and, for example, also for the signal amplifier unit 22 may be provided in the compartment, so that a longer usage period can also be implemented with minimal interruption.

In order to use the limited flight time of the drone 21 per battery charge with maximum efficiency, the drone always has to determine the best flight route. This applies both for the autonomous reception search and also, for example, for tracking the motor vehicle 20 when establishing the dynamic Internet connection. To achieve this, the flight path is optimized in an AI-based manner. An artificial intelligence (AI) is used for this purpose. This can determine possible positions having good reception on the basis of learned probabilities on the basis of the recognized surroundings and stored topography in the position map. The reception search is thus accelerated and valuable time is saved in particular for placing the emergency call.

The artificial intelligence can be implemented, for example, as a data processing device having a machine-trained algorithm, by which one or more probability positions in the surrounding area are determined depending on captured surroundings data. For the probability positions, the surroundings data indicate according to a predetermined probability that the second communication area 24 is provided. For the reception search, the drone 21 now flies to the determining probability positions to determine the position(s) of the position map.

In order to communicate with the motor vehicle 20, the drone 21 may be networked with the software architecture of the motor vehicle 20. A passenger of the motor vehicle 20 can initiate or control, for example, individual functions, such as the search flight or the following flight via this. At the same time, a report about the status of the drone, in particular the status of the reception search, the battery status or the remaining flight time, and the state of the position map can thus, for example, be output or displayed to the passenger via the screen via the communication connection between the drone 21 and the motor vehicle 20.

Overall, the examples of a drone system for establishing an Internet connection in dead zones and remote terrain are evident.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d 1865 (Fed. Cir. 2004).

1. A method of operating a communication system for a motor vehicle, comprising:
providing, by the communication system, a first communication area of the motor vehicle for data communication with a vehicle-external communication device located outside the first communication area ;
by at least one drone, autonomously determining a position map having at least one position in a surrounding area of the motor vehicle, at which a second communication area, different from the first communication area, is provided for the motor vehicle for the data communication with the vehicle-external communication device located within the second communication area, and
by the at least one drone, transmitting a repositioning signal to the motor vehicle, the repositioning signal containing the at least one position of the position map for repositioning of the motor vehicle from a current position of the motor vehicle to the at least one position, such that the motor vehicle is communicationally connectable upon the repositioning to the at least one position, to the vehicle-external communication device in the second communication area for the data communication.

2. The method according to claim 1, further comprising, by the motor vehicle, checking whether, according to a an emergency call criterion, an emergency call is required for the motor vehicle and/or at least one passenger, and, only when the emergency call is required, an emergency call signal of the motor vehicle is transmitted to an emergency call service by the at least one drone.

3. The method according to claim 1, comprising:
by the at least one drone, only in case a passenger of the motor vehicle declines the repositioning according to the repositioning signal, positioning a signal amplifier unit at a position indicated in the position map, such that the motor vehicle is communicationally connected for the data communication in the second communication area to the vehicle-external communication device via the signal amplifier unit.

4. The method according to claim 1, wherein the at least one drone includes a signal amplifier unit and the method further comprises:
by the at least one drone, only in case a passenger of the motor vehicle declines the repositioning according to the repositioning signal, positioning the at least one drone with the signal amplifier unit, at a position indicated in the position map, such that the motor vehicle is communicationally connected for the data communication in the second communication area to the vehicle-external communication device via the signal amplifier unit of the at least one drone.

5. The method according to claim 4, wherein, only in case that the motor vehicle is in a driving mode, the at least one drone adopts a position depending on a current position of the motor vehicle, wherein the at least one drone only adopts positions which were determined in the position map and at which the second communication area is provided.

6. The method according to claim 1, wherein the at least one drone comprises a data processing device having a machine-trained algorithm, wherein at least one probability position in the surrounding area is determined by the machine-trained algorithm depending on surroundings data captured, for which the surroundings data indicate according to a probability that the second communication area is provided and the at least one drone only flies toward the at least one probability position to determine the position map.

7. The method according to claim 1, wherein the at least one drone uses experience values of the motor vehicle or an other motor vehicle to determine the at least one position of the position map, wherein the experience values contain at least one previously known position in the surrounding area, at which the second communication area is provided.

8. The method according to claim 3, wherein each drone of the at least one drone includes a respective first energy storage device and at least one second energy storage device is provided for the at least one drone in the motor vehicle, and the at least one drone autonomously moves toward the motor vehicle depending on an energy storage device status of an energy storage device of the respective first energy storage device currently used by the at least one drone, to exchange the energy storage device currently used by the at least one drone for the at least one second energy storage device, and/or
at least one second energy storage device and/or at least one further signal amplifier unit is provided for the signal amplifier unit in the motor vehicle, and the at least one drone autonomously moves the signal amplifier unit toward the motor vehicle depending on an energy storage device status of an energy storage device currently used by the signal amplifier unit, to exchange the energy storage device currently used by the signal amplifier unit for the at least one second energy storage device or the at least one drone autonomously exchanges the signal amplifier unit for the at least one further signal amplifier unit depending on an energy storage device status of an energy storage device currently used by the signal amplifier unit.

9. The method according to claim 3, wherein the at least one drone and/or the signal amplifier unit provides a status signal to the motor vehicle to display a current operating status for a passenger, wherein the current operating status comprises an energy storage device status of a respectively currently used energy storage device of the at least one drone or the signal amplifier unit and/or the position map and/or a progress of the at least one drone in determining the position map.

10. A communication system for a motor vehicle, comprising:
a processor configured to establish data communication in a first communication area with a vehicle-external communication device; and
at least one drone stored in the motor vehicle, configured to,
autonomously determine a position map having at least one position in a surrounding area of the motor vehicle, at which a second communication area, different from the first communication area, is provided for the motor vehicle for the data communication with the vehicle-external communication device located within the second communication area, and
transmit a repositioning signal to the motor vehicle, the repositioning signal containing the at least one position of the position map for repositioning of the motor vehicle from a current position of the motor vehicle to the at least one position, such that the motor vehicle is communicationally connectable to the vehicle-external communication device in the second communication area for the data communication upon the repositioning to the at least one position.
